(19) United States
(12) Patent Application Publication
(10) Pub. No.: US 2026/0227631 A1
(43) Pub. Date: Aug. 6, 2026

(54) OPTICAL DEVICE AND WEARABLE DEVICE COMPRISING SAME

(71) Applicant: LG INNOTEK CO., LTD., Seoul (KR)

(72) Inventors: Sung Jae JIN, Seoul (KR); Kyu Tae LEE, Seoul (KR)

(21) Appl. No.: 19/146,104

(22) PCT Filed: Jan. 8, 2024
(86) PCT No.: PCT/KR2024/000322

§ 371 Date: Jul. 7, 2025

(30) Foreign Application Priority Data
Jan. 6, 2023 (KR) 10-2023-0002267

(51) Int. Cl. G02B 27/01; G02B 5/18

(52) U.S. Cl. CPC G02B 27/0172; G02B 5/1809; G02B 5/1814; G02B 5/1842; G02B 5/1861; G02B 2005/1804; G02B 2027/0125; G02B 2027/0178

(57) ABSTRACT

An optical device, according to one embodiment, comprises: a light guide comprising a first surface and a second surface; and a diffraction structure disposed on any one surface among the first surface and the second surface. The diffraction structure comprises: a first metal layer disposed on one surface of the light guide and comprising a plurality of diffraction patterns which are spaced apart from each other; and a second metal layer disposed on the upper surface of the diffraction patterns.

### TECHNICAL FIELD

Embodiments relate to an optical device and a wearable device including the same.

### BACKGROUND ART

With the recent advancement of technology, various types of wearable devices that can be worn on the body of a person are being used. Augmented reality (AR) devices are wearable devices in the form of glasses worn on the head of a user. The AR device provides visual information through a display. Accordingly, the user receives AR services.

AR refers to inserting a three-dimensional image into a real environment and mixing real-world information and virtual images.

The real-world information may include information not required by wearers. In addition, the real-world information may not have information required by the wearers. The AR device combines a real world and a virtual world.

Unlike a virtual reality device that blocks the field of view, the AR device allows the users to see ahead while in use. In addition, a display similar to a wide screen can be positioned in front of the eyes of the wearers, or the wearers can use various AR contents while wearing the AR device like regular glasses. In addition, the users use all spaces in a 360° direction centered on the users. Accordingly, the AR device can support an extended reality experience combining reality and AR contents. In addition, the AR device is being developed as a device with a technology that replaces smartphones in that it provides a display optimized for a visual point of the user in a state in which two hands of the user are free.

The AR device includes an optical module to provide AR images to the wearers. For example, the AR device may be an optical device composed of wearable glasses, and a projector that projects an image onto the wearable glasses may be coupled thereto.

Light emitted from the projector is incident on the eyes of the user through the optical device. Accordingly, the user can recognize the AR display.

Meanwhile, the light emitted from the projector may be diffracted by the optical device and then may be incident on the eyes of the user. To this end, the optical device may include a light guide and a diffraction structure.

The quality of the image recognized by the user varies depending on the diffraction efficiency of the diffraction structure. In addition, when the diffraction efficiency is decreased at a set range of angles, visibility can be decreased in the field of view at the set range of angles.

Accordingly, a light guide capable of solving the above problems is required.

### DETAILED DESCRIPTION OF INVENTION

### Technical Problem

Embodiments are directed to providing a light guide with increased diffraction efficiency at a wide angle.

### Technical Solution

An optical device according to an embodiment includes a light guide including a first surface and a second surface, and a diffraction structure disposed on any one surface of the first surface and the second surface, wherein the diffraction structure includes a plurality of diffraction patterns spaced apart from each other, and includes a first metal layer disposed on one surface of the light guide and a second metal layer disposed on an upper surface of the diffraction pattern.

Light may be incident toward the first surface, and the first metal layer may be disposed on the first surface.

The diffraction structure may include a first diffraction structure disposed on an area on which light is incident and a second diffraction structure disposed on an area from which the light is emitted.

The first metal layer and the second metal layer may be disposed to be spaced apart from each other.

A period, which is a distance the diffraction pattern repeats, may be defined, and the period may range from 300 nm to 600 nm.

A period, which is a distance the diffraction pattern repeats, may be defined, a fill factor, which is a ratio of a width of the diffraction pattern to the period, may be defined, and the fill factor may range from 20% to 80%.

A height of the diffraction pattern may range from 30 nm to 500 nm.

At least one of a thickness of the first metal layer and a thickness of the second metal layer may range from 10 nm to 70 nm.

A height of the diffraction pattern may be at least 10 nm greater than the thickness of the first metal layer.

The light may transmit through the diffraction pattern, or may be reflected from the diffraction pattern and incident into the light guide.

An angle of view of the light may range from 20° to 40°.

A wearable device according to an embodiment includes a light source member that emits light and an optical device on which the light is incident.

### Advantageous Effects

An optical device according to an embodiment includes an optical device.

The optical device includes a light guide and a diffraction structure.

The diffraction structure includes a plurality of diffraction patterns. In addition, a metal layer is disposed on each of an upper surface of the diffraction structure and one surface of the light guide. The metal layers are disposed to be spaced apart from each other.

Accordingly, a plasmonic effect occurs in each of the metal layers. In addition, the plasmonic effects occurring in each of the metal layers interact with each other.

Accordingly, the optical device according to the embodiment can have uniform diffraction efficiency at an angle of view within a wide angle range. In addition, the optical device according to the embodiment can have high diffraction efficiency at an angle of view within a wide angle range. Specifically, the optical device according to the embodiment can have uniform and high diffraction efficiency at an angle of view of 20° to 40°.

In addition, a period, fill factor, and height of a diffraction pattern according to the embodiment can be controlled. In addition, a thickness of the metal layer can be controlled.

Accordingly, the optical device according to the embodiment can have uniform and high diffraction efficiency at an angle of view within a wide angle range.

### DESCRIPTION OF DRAWINGS

FIG. 1 is a view showing a display device including a light guide according to an embodiment.

FIG. 2 is an enlarged view of area A in FIG. 1.

FIG. 3 is a view for describing another location of a diffraction structure according to the embodiment.

FIG. 4 is a view for describing another shape of a diffraction pattern of the diffraction structure according to the embodiment.

FIG. 5 is a view for describing diffraction efficiency of an optical device according to a comparative example.

FIGS. 6 to 13 are graphs for describing diffraction efficiencies of optical devices according to examples and comparative examples.

FIGS. 14 and 15 are graphs for describing diffraction efficiency in another wavelength band of the optical device according to the embodiment.

FIGS. 16 and 17 are graphs for describing the diffraction efficiency of the optical device according to the comparative example.

FIG. 18 is a view for describing diffraction efficiency according to a height of the diffraction structure according to the embodiment.

FIGS. 19 and 20 are graphs for describing the diffraction efficiency according to the height of the diffraction structure according to the embodiment.

FIGS. 21 and 22 are graphs for describing diffraction efficiency according to a period of the diffraction structure according to the embodiment.

FIG. 23 is a graph for describing diffraction efficiency according to an arrangement of a metal layer of the diffraction structure according to the embodiment.

FIG. 24 is a view showing a wearable device to which the optical device according to the embodiment is applied.

### MODES OF THE INVENTION

Hereinafter, exemplary embodiments of the present invention will be described in detail with reference to the accompanying drawings. However, the technical spirit of the present invention is not limited to some of the described embodiments, but may be implemented in various different forms, and one or more of the components among the embodiments may be used by being selectively coupled or substituted without departing from the scope of the technical spirit of the present invention.

In addition, terms (including technical and scientific terms) used in embodiments of the present invention may be construed as meaning that may be generally understood by those skilled in the art to which the present invention pertains unless explicitly specifically defined and described, and the meanings of the commonly used terms, such as terms defined in a dictionary, may be construed in consideration of contextual meanings of related technologies.

In addition, the terms used in the embodiments of the present invention are for describing the embodiments and are not intended to limit the present invention. In the present specification, a singular form may include a plural form unless otherwise specified in the phrase, and when described as “at least one (or one or more) of A, B, and C,” one or more of all possible combinations of A, B, and C may be included.

In addition, terms such as first, second, A, B, (a), and (b) may be used to describe components of the embodiments of the present invention. These terms are only for the purpose of distinguishing one component from another component, and the nature, sequence, order, etc. of the corresponding components is not limited by these terms.

In addition, when a certain component is described as being “connected,” “coupled,” or “joined” to another component, it may include a case in which the certain component is directly connected, coupled, or joined to another component, but also a case in which the certain component is “connected,” “coupled,” or “joined” to another component with still another component present between the certain component and another component.

In addition, when the certain component is described as being formed or disposed “on (above) or below (under)” another component, “on (above)” or “below (under)” may include not only a case in which two components are in direct contact with each other, but also a case in which one or more other components are formed or disposed between the two components.

In addition, when described as “on (above) or below (under),” it may include the meaning of not only an upward direction but also a downward direction based on one component.

Hereinafter, a light guide according to an embodiment will be described with reference to the drawings.

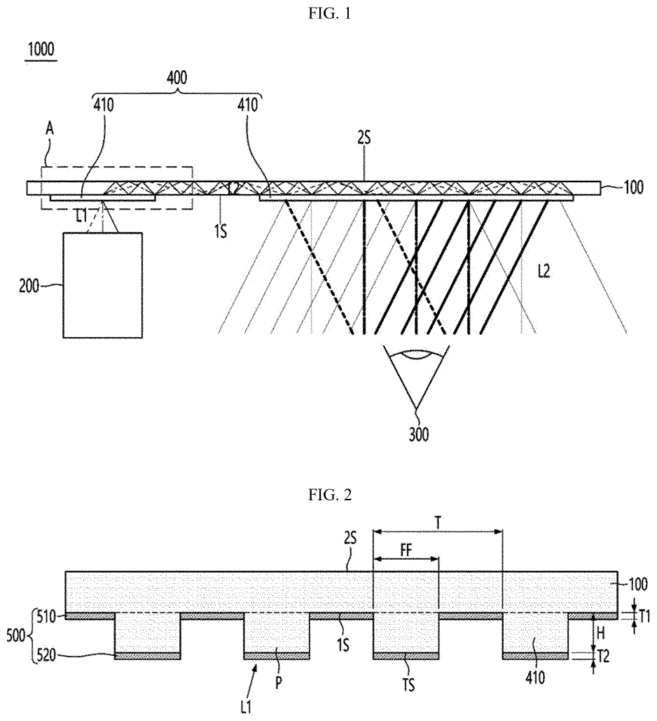

FIG. 1 is a view showing a part of a wearable device 1000 including a light guide according to an embodiment. The wearable device 1000 to be described below may be an augmented reality (AR) device.

Referring to FIG. 1, the wearable device 1000 includes an optical device and a light source member 200. The optical device includes a light guide 100 and a diffraction structure 400.

The light guide 100 includes a first surface 1S and a second surface 2S opposite to the first surface 1S.

Light is incident on the first surface 1S. In addition, the light is emitted from the first surface 1S. Specifically, first light L1 emitted from the light source member 200 is emitted toward the first surface 1S of the light guide 100. Accordingly, the first light L1 is incident into the light guide 100 through the first surface 1S.

The first light L1 incident into the light guide 100 is totally reflected inside the light guide 100 and emitted to the outside of the light guide 100 through the first surface 1S. Accordingly, second light L2 emitted through the first surface 1S is transmitted to a user 300.

The light guide 100 includes a material that transmits light. The light guide 100 has a refractive index within a set range. Specifically, the light guide includes a material having a refractive index of 1.82 or more. For example, the light guide includes glass having a refractive index of 1.82 to 2.

The light guide may have various shapes. For example, the light guide may have a circular shape including a curved surface or an elliptical shape. Alternatively, the light guide may have a polygonal shape such as a triangle, a quadrangle, etc.

The light guide guides light. For example, the light guide may be a waveguide.

The light source member 200 may include a projector. The first light L1 emitted from the light source member 200 may include image information. That is, the first light L1 incident into the light guide 100 includes image information. Accordingly, the user 300 receives the image information emitted from the light source member 200 through the light guide 100.

The optical device includes a plurality of diffraction structures 400. Specifically, the optical device includes a first diffraction structure 410 and a second diffraction structure 420. The first diffraction structure 410 is disposed between the light guide 100 and the light source member 200. That is, the first diffraction structure 410 is disposed on an area on which the first light L1 is incident. In addition, the second diffraction structure 420 is disposed between the light guide 100 and the user 300. That is, the second diffraction structure 420 is disposed on an area from which the second light L2 is emitted.

Specifically, the first diffraction structure 410 is disposed along a path of the light between the light guide 100 and the light source member 200. In addition, the second diffraction structure 420 is disposed along the path of light between the light guide 100 and the user 300.

Accordingly, the first light L1 emitted from the light source member 200 is diffracted by the first diffraction structure 410 and incident into the light guide 100. In addition, the second light L2 emitted from the light guide 100 is diffracted by the second diffraction structure 420 and transmitted to the user 300.

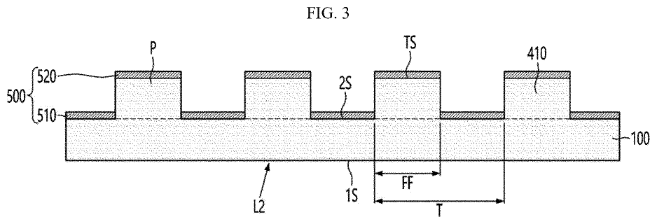

FIGS. 2 and 3 are views for describing the optical device according to the embodiment. FIG. 2 is an enlarged view of area A in FIG. 1. FIG. 3 is a view for describing another location of a diffraction structure. In FIGS. 2 and 3, the first diffraction structure 410 will be mainly described. In addition, the descriptions of FIGS. 2 and 3 may also be applied to the second diffraction structure 420 in the same manner.

Referring to FIG. 2, the first diffraction structure 410 is disposed below the light guide 100. Specifically, the first diffraction structure 410 may be disposed on the first surface 1S of the light guide 100.

The first diffraction structure 410 includes a plurality of diffraction patterns P. That is, the first diffraction structure 410 is defined as a set of the plurality of diffraction patterns P.

The first light L1 emitted from the light source member 200 is diffracted through the diffraction patterns P. The diffracted light is incident into the light guide 100. That is, the diffraction pattern P may be a transmissive pattern.

The plurality of diffraction patterns P are disposed on the first surface 1S. The plurality of diffraction patterns P protrude from the first surface 1S.

Alternatively, referring to FIG. 3, the plurality of diffraction patterns may be disposed on the second surface 2S. The plurality of diffraction patterns P protrude from the second surface 2S.

The first light L1 emitted from the light source member 200 is diffracted through the diffraction patterns P. The diffracted light is incident into the light guide 100. That is, the diffraction pattern P may be a reflection pattern.

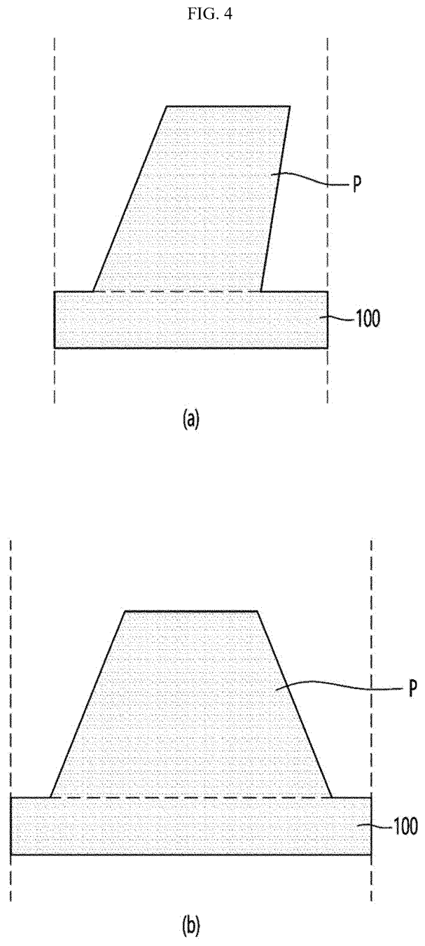

The diffraction pattern P may be formed in various shapes. Referring to FIGS. 2 and 3, a cross section of the diffraction pattern P may be formed in a rectangular shape. Alternatively, referring to FIG. 4, the cross section of the diffraction pattern P may be formed in a trapezoidal shape (see FIG. 4A) in which left and right surfaces are asymmetrical. Alternatively, the cross section of the diffraction pattern P may be formed in a trapezoidal shape (see FIG. 4B) in which left and right surfaces are symmetrical.

The plurality of diffraction patterns P are spaced apart from each other. Accordingly, the plurality of diffraction patterns P have a period T, a fill factor FF, and a height H. The period Tis defined as a distance the plurality of diffraction patterns P repeat. The fill factor FF is defined as a ratio of a width of the diffraction pattern P to the period T. The height H is defined as the maximum distance from the first surface 1S to an upper surface TS. Alternatively, the height H is defined as the maximum distance from the second surface 2S to the upper surface TS.

The first diffraction structure 410 includes a metal layer 500. The metal layer 500 includes a first metal layer 510 and a second metal layer 520. The first metal layer 510 is disposed on the light guide 100. Specifically, the first metal layer 510 is disposed on the first surface 1S.

The second metal layer 520 is disposed on the diffraction pattern P. Specifically, the second metal layer 520 is disposed on the upper surface TS of the diffraction pattern P.

Accordingly, the first metal layer 510 and the second metal layer 520 may be spaced apart from each other. That is, the first metal layer 510 and the second metal layer 520 are spaced apart from each other by the height H of the diffraction pattern P.

Accordingly, the plasmonic effect by the first metal layer 510 and the plasmonic effect by the second metal layer 520 may interact with each other, thereby increasing the diffraction efficiency of the first diffraction structure 410.

The first metal layer 510 and the second metal layer 520 may include gold (Au), silver (Ag), or aluminum (Al). The first metal layer 510 and the second metal layer 520 are formed with a thin film thickness. For example, the first metal layer 510 and the second metal layer 520 are disposed with a thickness in units of nanometers (nm).

The first diffraction structure 410 has increased diffraction efficiency by the first metal layer 510 and the second metal layer 520.

Specifically, the first diffraction structure 410 has a plasmonic metasurface formed by the first metal layer 510 and the second metal layer 520. Accordingly, increased diffraction efficiency can be achieved even at a wide angle of view using the plasmonic effect. Here, the wide angle is an angle of 20° to 40°.

The plasmonic refers to a phenomenon in which free electrons in a metal collectively vibrate due to a reaction between external light and the metal. The collective vibration movement of the free electrons appears because the light energy of the incident light is transferred to the free electrons through resonance. In particular, the plasmonic is referred to as surface plasmon because it appears at an interface between a metal and a dielectric. The more similar a natural frequency of the free electron in the metal and a frequency of incident waves are, the more efficiently the energy is transferred. The transferred energy is stored in the form of a near field in a surface of the metal.

The first diffraction structure 410 generates the plasmonic effect by the first metal layer 510 and the second metal layer 520. Accordingly, the diffraction efficiency of the first diffraction structure 410 is increased.

To have increased diffraction efficiency at a wide angle, the period T, the height H, the fill factor FF, and the thickness of the metal layer in the first diffraction structure 410 are provided within the set ranges.

Specifically, the period T of the diffraction pattern P may be 300 nm or more. Specifically, the period T of the diffraction pattern P may range from 300 nm to 600 nm.

In addition, the fill factor FF of the diffraction pattern P may be 20% or more. Specifically, the fill factor FF of the diffraction pattern P may range from 20% to 80%.

In addition, the height H of the diffraction pattern P may be 30 nm or more. Specifically, the height H of the diffraction pattern P may range from 30 nm to 500 nm.

In addition, at least one of a thickness T1 of the first metal layer 510 and a thickness T2 of the second metal layer 520 may be 10 nm or more. Specifically, at least one of the thickness T1 of the first metal layer 510 and the thickness T2 of the second metal layer 520 may range from 10 nm to 70 nm.

In addition, the height H of the diffraction pattern P may be greater than at least one of the thickness T1 of the first metal layer 510 and the thickness T2 of the second metal layer 520. For example, the height H of the diffraction pattern P may be greater than the thickness T1 of the first metal layer 510. Specifically, the height H of the diffraction pattern P may be at least 10 nm greater than the thickness T1 of the first metal layer 510.

Accordingly, the first metal layer 510 and the second metal layer 520 can be prevented from being in contact with each other. Accordingly, the diffraction efficiency of the first diffraction structure 410 can be increased.

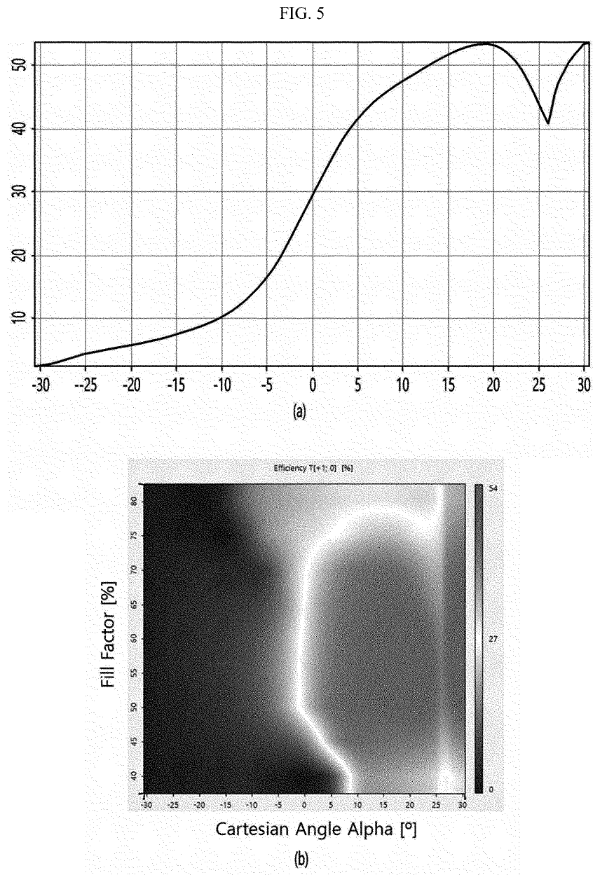

FIG. 5 is a graph for describing diffraction efficiency when no metal layer is disposed on the first diffraction structure 410.

Referring to FIG. 5A, when no metal layer is disposed, diffraction efficiency varies depending on a size of an angle of view. Specifically, excellent diffraction efficiency is obtained at an angle of view of 5° to 25°. However, the diffraction efficiency decreases within a range of other angles of view. Accordingly, the diffraction efficiency decreases in a wide-angle range.

In addition, referring to FIG. 5B, when no metal layer is disposed, the diffraction efficiency varies depending on the fill factor. Specifically, excellent diffraction efficiency is obtained at an angle of 5° to 30°. However, the diffraction efficiency decreases within a range of other angles. Accordingly, the diffraction efficiency decreases in a wide-angle range.

Accordingly, the optical device according to the embodiment includes a plurality of metal layers. The plurality of metal layers are disposed at different positions. In addition, the plurality of metal layers are spaced apart from each other. Accordingly, the optical device according to the embodiment can have increased diffraction efficiency due to interaction of the plasmonic effects of the metal layer and the diffraction pattern.

Hereinafter, the optical device according to the embodiment will be described in detail through examples and comparative examples.

### EXAMPLE 1

A plurality of diffraction patterns were disposed on a light guide. In addition, a metal layer was disposed on each of an upper surface of the diffraction pattern and one surface of the light guide. Accordingly, an optical device was manufactured.

Subsequently, light in a green light wavelength range was emitted toward the optical device. The light was incident into the light guide through the diffraction pattern.

A refractive index of the light guide was 1.5. In addition, a wavelength of the light was 528 nm. In addition, a period of the diffraction pattern was 415 nm. In addition, a fill factor of the diffraction pattern was 53.7%. In addition, a height of the diffraction pattern was 164 nm. In addition, the metal layer included silver (Ag). In addition, a thickness of the metal layer was 20 nm.

Subsequently, diffraction efficiency of the optical device was measured.

### EXAMPLE 2

A plurality of diffraction patterns were disposed on a light guide. In addition, a metal layer was disposed on each of an upper surface of the diffraction pattern and one surface of the light guide. Accordingly, an optical device was manufactured.

Subsequently, light in a green light wavelength range was emitted toward the optical device. The light was incident into the light guide through the diffraction pattern.

A refractive index of the light guide was 1.5. In addition, a wavelength of the light was 528 nm. In addition, a period of the diffraction pattern was 415 nm. In addition, a fill factor of the diffraction pattern was 25%. In addition, a height of the diffraction pattern was 60 nm. In addition, the metal layer included aluminum (Al). In addition, a thickness of the metal layer was 20 nm.

Subsequently, diffraction efficiency of the optical device was measured.

### EXAMPLE 3

A plurality of diffraction patterns were disposed on a light guide. In addition, a metal layer was disposed on each of an upper surface of the diffraction pattern and one surface of the light guide. Accordingly, an optical device was manufactured.

Subsequently, light in a green light wavelength range was emitted toward the optical device. The light was incident into the light guide through the diffraction pattern.

A refractive index of the light guide was 1.8. In addition, a wavelength of the light was 528 nm. In addition, a period of the diffraction pattern was 397 nm. In addition, a fill factor of the diffraction pattern was 28%. In addition, a height of the diffraction pattern was 70 nm. In addition, the metal layer included aluminum (Al). In addition, a thickness of the metal layer was 20 nm.

Subsequently, diffraction efficiency of the optical device was measured.

### EXAMPLE 4

A plurality of diffraction patterns were disposed on a light guide. In addition, a metal layer was disposed on each of an upper surface of the diffraction pattern and one surface of the light guide. Accordingly, an optical device was manufactured.

Subsequently, light in a green light wavelength range was emitted toward the optical device. The light was reflected from the diffraction pattern and incident into the light guide.

A refractive index of the light guide was 1.8. In addition, a wavelength of the light was 528 nm. In addition, a period of the diffraction pattern was 397 nm. In addition, a fill factor of the diffraction pattern was 77%. In addition, a height of the diffraction pattern was 40 nm. In addition, the metal layer included aluminum (Al). In addition, a thickness of the metal layer was 20 nm.

Subsequently, diffraction efficiency of the optical device was measured.

### EXAMPLE 5

A plurality of diffraction patterns were disposed on a light guide. In addition, a metal layer was disposed on each of an upper surface of the diffraction pattern and one surface of the light guide. Accordingly, an optical device was manufactured.

Subsequently, light in a blue light wavelength range was emitted toward the optical device. The light was incident into the light guide through the diffraction pattern.

A refractive index of the light guide was 1.5. In addition, a wavelength of the light was 455 nm. In addition, a period of the diffraction pattern was 355 nm. In addition, a fill factor of the diffraction pattern was 38%. In addition, a height of the diffraction pattern was 80 nm. In addition, the metal layer included silver (Ag). In addition, a thickness of the metal layer was 20 nm.

Subsequently, diffraction efficiency of the optical device was measured.

### EXAMPLE 6

A plurality of diffraction patterns were disposed on a light guide. In addition, a metal layer was disposed on each of an upper surface of the diffraction pattern and one surface of the light guide. Accordingly, an optical device was manufactured.

Subsequently, light in a red light wavelength range was emitted toward the optical device. The light was incident into the light guide through the diffraction pattern.

A refractive index of the light guide was 1.5. In addition, a wavelength of the light was 621 nm. In addition, a period of the diffraction pattern was 480 nm. In addition, a fill factor of the diffraction pattern was 28%. In addition, a height of the diffraction pattern was 90 nm. In addition, the metal layer included silver (Ag). In addition, a thickness of the metal layer was 30 nm.

Subsequently, diffraction efficiency of the optical device was measured.

### Comparative Example 1

An optical device was manufactured in the same manner as in Example 1, except that no metal layer was disposed on the diffraction pattern.

Subsequently, diffraction efficiency of the optical device was measured.

### Comparative Example 2

An optical device was manufactured in the same manner as in Example 2, except that no metal layer was disposed on the diffraction pattern.

Subsequently, diffraction efficiency of the optical device was measured.

### Comparative Example 3

An optical device was manufactured in the same manner as in Example 3, except that no metal layer was disposed on the diffraction pattern.

Subsequently, diffraction efficiency of the optical device was measured.

### Comparative Example 4

An optical device was manufactured in the same manner as in Example 4, except that no metal layer was disposed on the diffraction pattern.

Subsequently, diffraction efficiency of the optical device was measured.

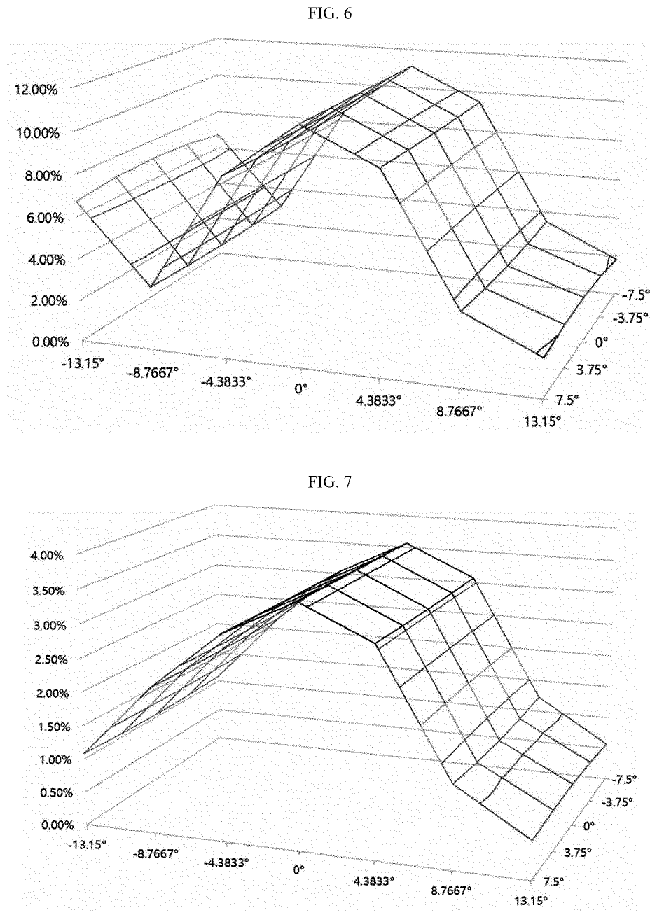

FIGS. 6 and 7 are graphs showing diffraction efficiencies of optical devices according to Example 1 and Comparative example 1. An X-axis is an incident angle of light. That is, 0° in the X-axis refers to an optical axis. That is, the X-axis refers to a range of an angle of view. In addition, a Y-axis is diffraction efficiency.

Referring to FIG. 6, the optical device according to Example 1 has diffraction efficiency of 4% or more within a range of all angles. Accordingly, the optical device according to Example 1 has uniform diffraction efficiency within a wide-angle range. In addition, the optical device according to Example 1 has high diffraction efficiency within the wide-angle range.

On the other hand, referring to FIG. 7, the optical device according to Comparative Example 1 has high diffraction efficiency only within a range of angles of 0° to +4°. In addition, the optical device has low diffraction efficiency within a range of other angles. That is, the optical device according to Comparative Example 1 has high diffraction efficiency only within a narrow-angle range.

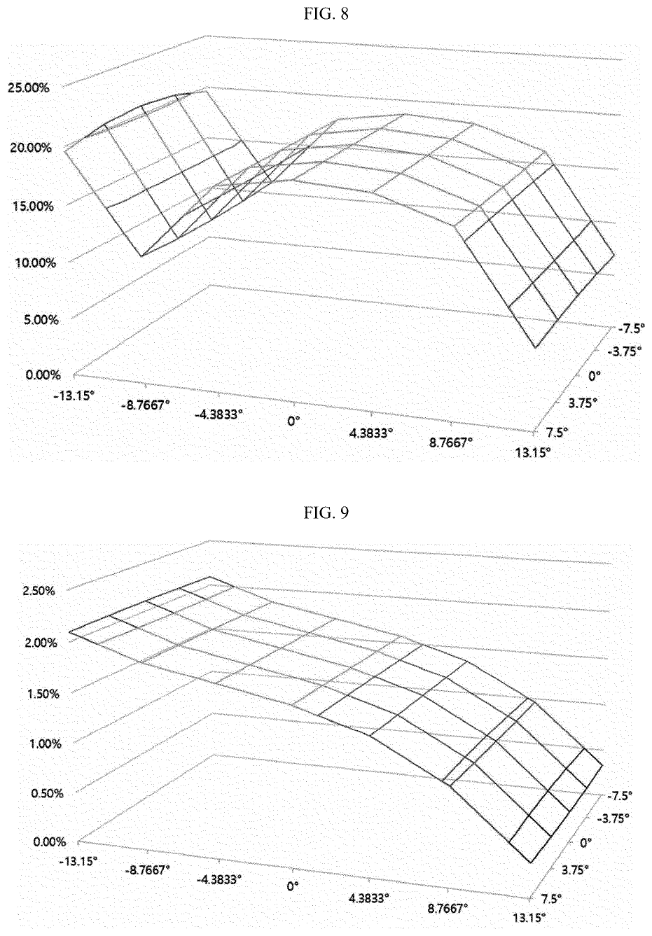

FIGS. 8 and 9 are graphs showing diffraction efficiencies of optical devices according to Example 2 and Comparative example 2. An X-axis is an incident angle of light. That is, 0° in the X-axis refers to an optical axis. That is, the X-axis refers to a range of an angle of view. In addition, a Y-axis is diffraction efficiency.

Referring to FIG. 8, the optical device according to Example 2 has diffraction efficiency of 5% or more within a range of all angles. Accordingly, the optical device according to Example 2 has uniform diffraction efficiency within a wide-angle range. In addition, the optical device according to Example 2 has high diffraction efficiency within the wide-angle range.

On the other hand, referring to FIG. 9, the optical device according to Comparative Example 2 has high diffraction efficiency only within a range of angles of 0° to −13°. In addition, the optical device has low diffraction efficiency within a range of other angles. That is, the optical device according to Comparative Example 2 has high diffraction efficiency only within a narrow-angle range.

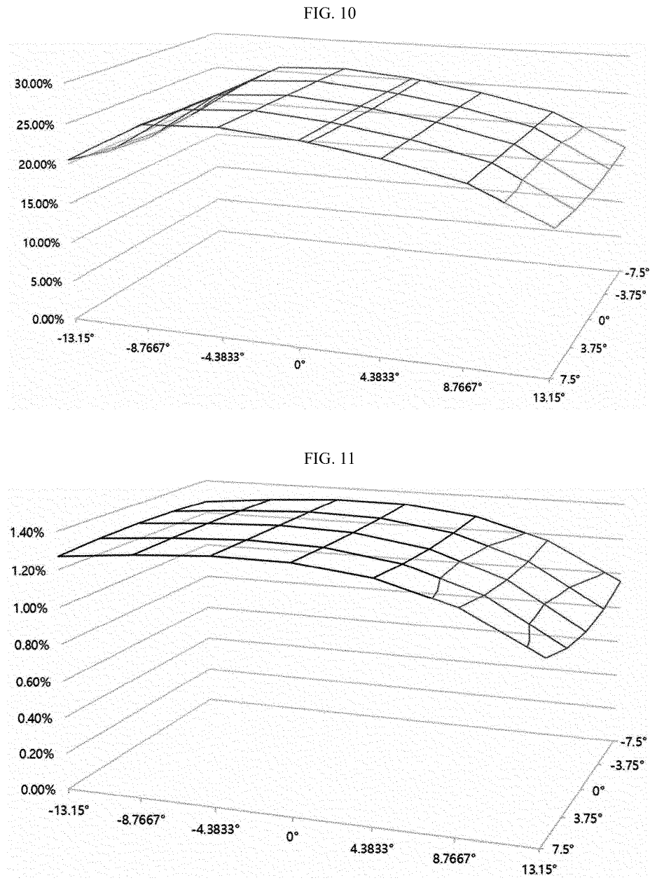

FIGS. 10 and 11 are graphs showing diffraction efficiencies of optical devices according to Example 3 and Comparative example 3. An X-axis is an incident angle of light. That is, 0° in the X-axis refers to an optical axis. That is, the X-axis refers to a range of an angle of view. In addition, a Y-axis is diffraction efficiency.

Referring to FIG. 10, the optical device according to Example 3 has diffraction efficiency of 20% or more within a range of all angles. Accordingly, the optical device according to Example 3 has uniform diffraction efficiency within a wide-angle range. In addition, the optical device according to Example 3 has high diffraction efficiency within the wide-angle range.

On the other hand, referring to FIG. 11, the optical device according to Comparative Example 3 has high diffraction efficiency only within a range of angles of 0° to −13°. In addition, the optical device has low diffraction efficiency within a range of other angles. That is, the optical device according to Comparative Example 3 has high diffraction efficiency only within a narrow-angle range.

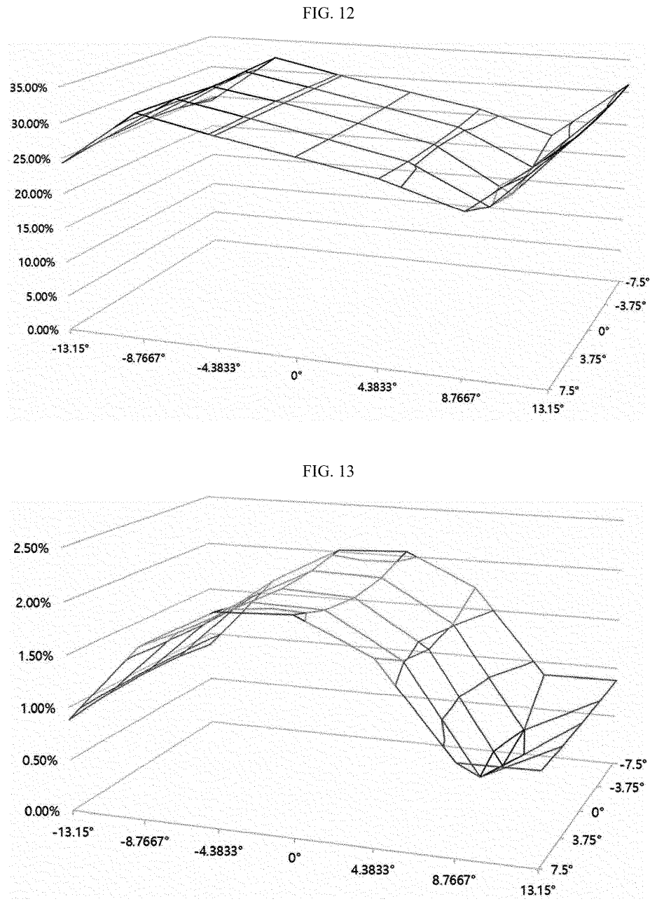

FIGS. 12 and 13 are graphs showing diffraction efficiencies of optical devices according to Example 4 and Comparative example 4. An X-axis is an incident angle of light. That is, 0° in the X-axis refers to an optical axis. That is, the X-axis refers to a range of an angle of view. In addition, a Y-axis is diffraction efficiency.

Referring to FIG. 12, the optical device according to Example 4 has diffraction efficiency of 25% or more within a range of all angles. Accordingly, the optical device according to Example 4 has uniform diffraction efficiency within a wide-angle range. In addition, the optical device according to Example 4 has high diffraction efficiency within the wide-angle range.

On the other hand, referring to FIG. 13, the optical device according to Comparative Example 3 has high diffraction efficiency only within a range of angles of 0° to +4°. In addition, the optical device has low diffraction efficiency within a range of other angles. That is, the optical device according to Comparative Example 4 has high diffraction efficiency only within a narrow-angle range.

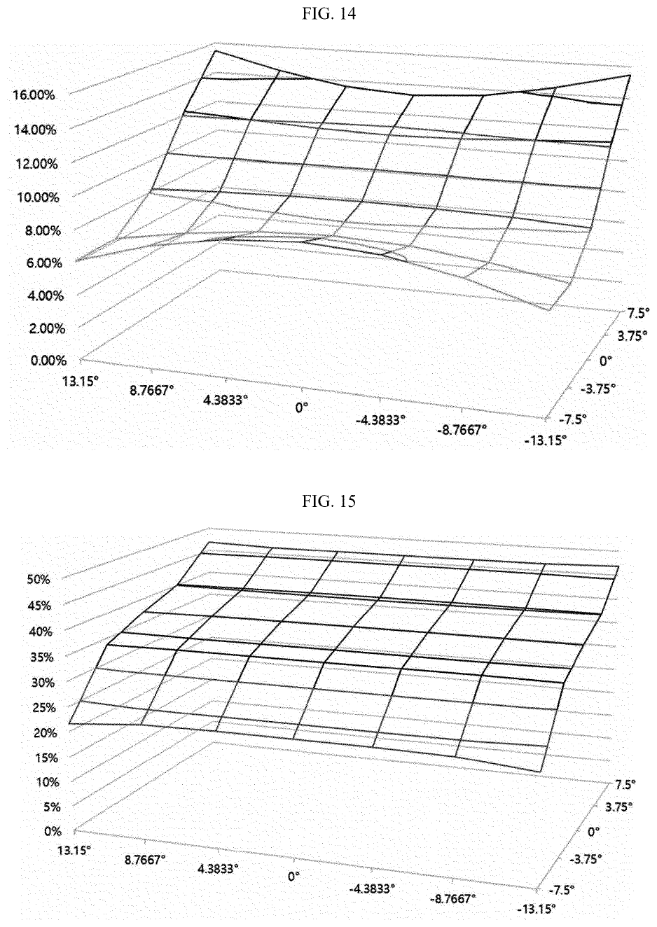

FIGS. 14 and 15 are graphs showing diffraction efficiencies of optical devices according to Examples 5 and 6. An X-axis is an incident angle of light. That is, 0° in the X-axis refers to an optical axis. That is, the X-axis refers to a range of an angle of view. In addition, a Y-axis is diffraction efficiency.

Referring to FIG. 14, the optical device according to Example 5 has diffraction efficiency of 6% or more within a range of all angles. Accordingly, the optical device according to Example 5 has uniform diffraction efficiency within a wide-angle range. In addition, the optical device according to Example 5 has high diffraction efficiency within the wide-angle range.

Referring to FIG. 15, the optical device according to Example 6 has diffraction efficiency of 20% or more within a range of all angles. Accordingly, the optical device according to Example 6 has uniform diffraction efficiency within a wide-angle range. In addition, the optical device according to Example 6 has high diffraction efficiency within the wide-angle range.

Referring to Examples 1 to 6, the optical device has increased diffraction efficiency by the metal layer. The optical device includes a first metal layer disposed on one surface of the light guide and a second metal layer disposed on an upper surface of the diffraction pattern.

The plasmonic effect by the first metal layer and the plasmonic effect by the second metal layer interact with each other. Accordingly, the optical device according to the embodiment can have increased diffraction efficiency.

### EXAMPLE 7

A plurality of diffraction patterns were disposed on a light guide. In addition, a metal layer was disposed on each of an upper surface of the diffraction pattern and one surface of the light guide. Accordingly, an optical device was manufactured.

Subsequently, light in a green light wavelength range was emitted toward the optical device. The light was incident into the light guide through the diffraction pattern.

A refractive index of the light guide was 1.5. In addition, a wavelength of the light was 528 nm. In addition, a period of the diffraction pattern was 420 nm. In addition, a fill factor of the diffraction pattern was 20%. In addition, a height of the diffraction pattern was 100 nm. In addition, the metal layer included silver (Ag). In addition, a thickness of the metal layer was 80 nm.

Subsequently, diffraction efficiency of the optical device was measured.

### Comparative Example 5

An optical device was manufactured in the same manner as in Example 7, except that a thickness of a metal layer was 90 nm.

Subsequently, diffraction efficiency of the optical device was measured.

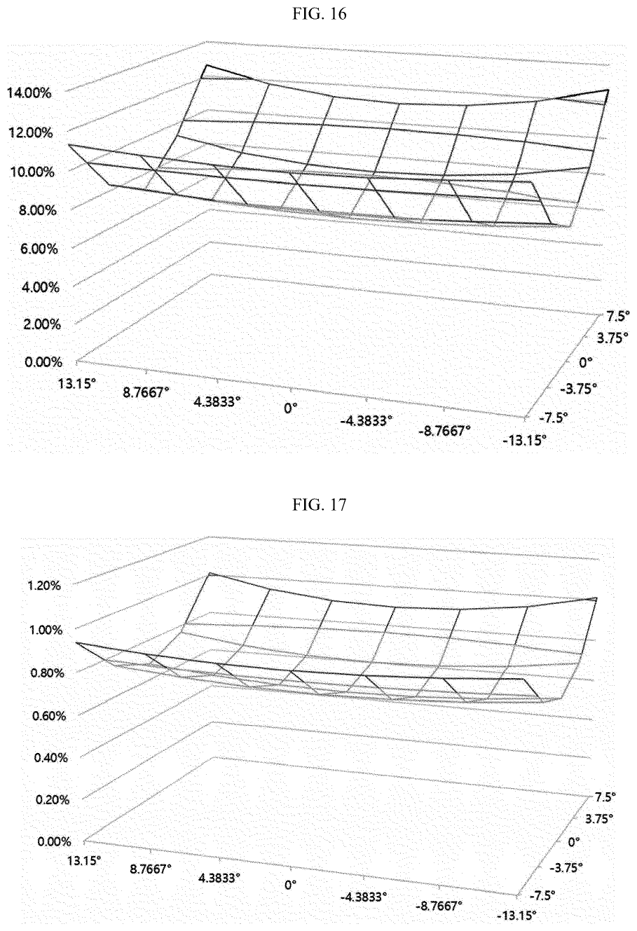

FIGS. 16 and 17 are graphs showing diffraction efficiencies of optical devices according to Example 7 and Comparative example 5. An X-axis is an incident angle of light. That is, 0° in the X-axis refers to an optical axis. That is, the X-axis refers to a range of an angle of view. In addition, a Y-axis is diffraction efficiency.

Referring to FIG. 16, the optical device according to Example 7 has diffraction efficiency of 7% or more within a range of all angles. Accordingly, the optical device according to Example 7 has uniform diffraction efficiency within a wide-angle range. In addition, the optical device according to Example 7 has high diffraction efficiency within the wide-angle range.

Referring to FIG. 17, the optical device according to Comparative Example 5 has diffraction efficiency of 0.8% or more within a range of all angles. The optical device according to Comparative Example 5 has uniform diffraction efficiency within a wide-angle range. However, the optical device according to Comparative Example 5 has low diffraction efficiency.

Referring to Example 7 and Comparative Example 5, the diffraction efficiency of the optical device according to the example is related to the thickness of the metal layer. That is, when the thickness of the metal layer ranges from 10 nm to 70 nm, the optical device has high and uniform diffraction efficiency within a wide-angle range. On the other hand, when the thickness of the metal layer exceeds the above range, the optical device has uniform diffraction efficiency within a wide-angle range. However, the optical device has low diffraction efficiency.

### EXAMPLE 8

A plurality of diffraction patterns were disposed on a light guide. In addition, a metal layer was disposed on each of an upper surface of the diffraction pattern and one surface of the light guide. Accordingly, an optical device was manufactured.

Subsequently, light in a green light wavelength range was emitted toward the optical device. The light was incident into the light guide through the diffraction pattern.

A refractive index of the light guide was 1.5. In addition, a wavelength of the light was 528 nm. In addition, a period of the diffraction pattern was 510 nm. In addition, a fill factor of the diffraction pattern was 30%. In addition, a height of the diffraction pattern was 275 nm. In addition, the metal layer included silver (Ag). In addition, a thickness of the metal layer was 30 nm.

Subsequently, diffraction efficiency of the optical device was measured.

### EXAMPLE 9

A plurality of diffraction patterns were disposed on a light guide. In addition, a metal layer was disposed on each of an upper surface of the diffraction pattern and one surface of the light guide. Accordingly, an optical device was manufactured.

Subsequently, light in a green light wavelength range was emitted toward the optical device. The light was incident into the light guide through the diffraction pattern.

A refractive index of the light guide was 1.5. In addition, a wavelength of the light was 528 nm. In addition, a period of the diffraction pattern was 420 nm. In addition, a fill factor of the diffraction pattern was 50%. In addition, a height of the diffraction pattern was 390 nm. In addition, the metal layer included silver (Ag). In addition, a thickness of the metal layer was 30 nm.

Subsequently, diffraction efficiency of the optical device was measured.

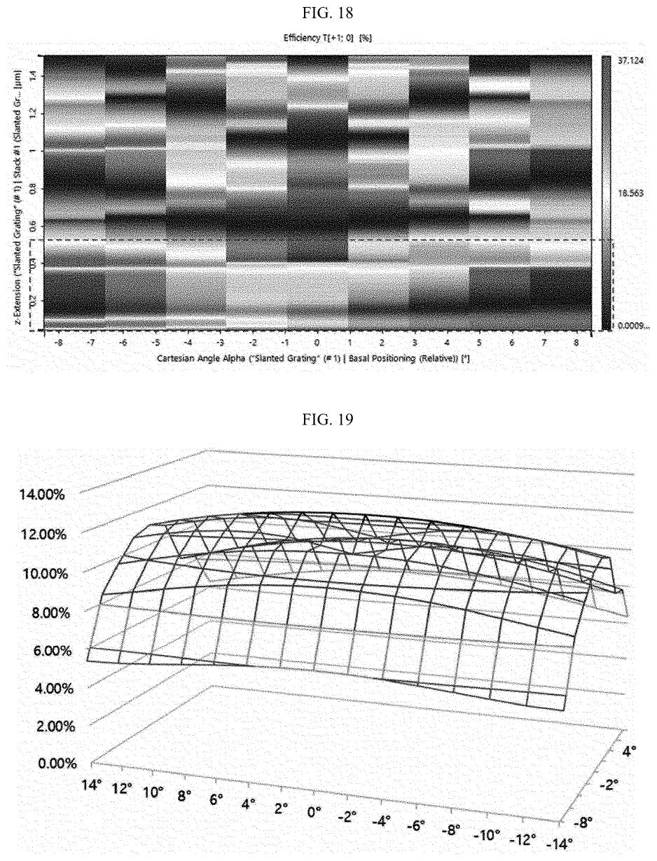

FIG. 18 is a graph showing diffraction efficiency according to a height of a diffraction pattern. An X-axis is an incident angle of light. That is, 0° in the X-axis refers to an optical axis. That is, the X-axis refers to a range of an angle of view. In addition, a Y-axis refers to a height of a diffraction pattern.

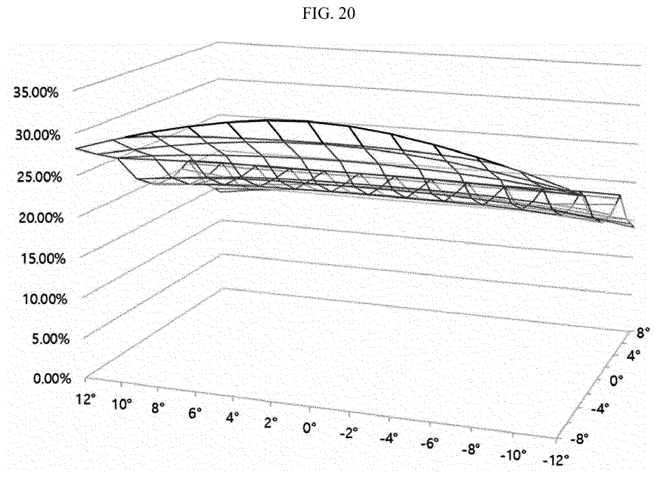

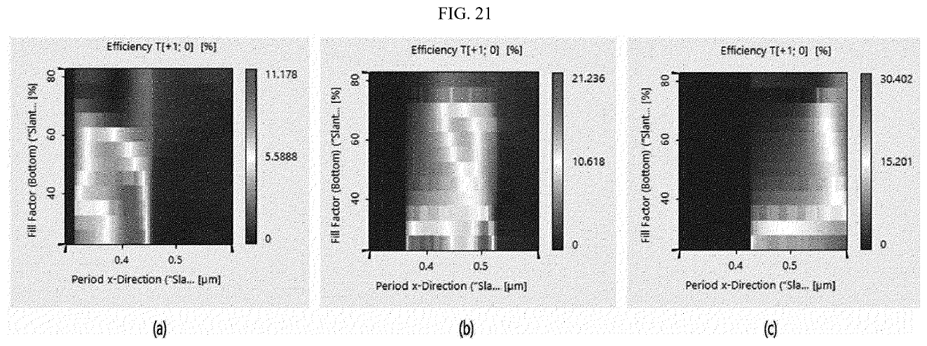

FIGS. 19 and 20 are graphs showing diffraction efficiencies of optical devices according to Example 8 and Comparative example 9. An X-axis is an incident angle of light. That is, 0° in the X-axis refers to an optical axis. That is, the X-axis refers to a range of an angle of view. In addition, a Y-axis is diffraction efficiency.

Referring to FIG. 19, the optical device according to Example 8 has diffraction efficiency of 6% or more within a range of all angles. Accordingly, the optical device according to Example 8 has uniform diffraction efficiency within a wide-angle range. In addition, the optical device according to Example 8 has high diffraction efficiency within the wide-angle range.

Referring to FIG. 20, the optical device according to Example 9 has diffraction efficiency of 20% or more within a range of all angles. Accordingly, the optical device according to Example 9 has uniform diffraction efficiency within a wide-angle range. In addition, the optical device according to Example 9 has high diffraction efficiency within the wide-angle range.

Referring to FIGS. 18 to 20, the diffraction efficiency of the optical device is related to the height of the diffraction pattern. That is, when the height of the diffraction pattern ranges from 30 nm to 500 nm, the optical device has high and uniform diffraction efficiency within a wide-angle range. On the other hand, when the height of the diffraction pattern exceeds the above range, the optical device has low diffraction efficiency.

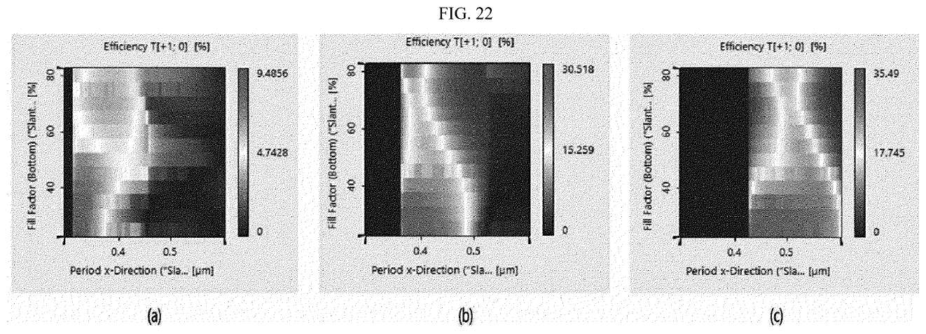

FIGS. 21 and 22 are graphs for comparing diffraction efficiency of an optical device according to a period of a diffraction pattern.

FIG. 21A shows diffraction efficiency of an optical device when a period of a diffraction pattern is 455 nm. FIG. 21B shows diffraction efficiency of the optical device when the period of the diffraction pattern is 528 nm. FIG. 21C shows diffraction efficiency of the optical device when the period of the diffraction pattern is 621 nm.

FIG. 22A shows diffraction efficiency of the optical device when the period of the diffraction pattern is 455 nm. FIG. 22B shows diffraction efficiency of the optical device when the period of the diffraction pattern is 528 nm. FIG. 22C shows diffraction efficiency of the optical device when the period of the diffraction pattern is 621 nm.

Referring to FIGS. 21 and 22, the diffraction efficiency of the optical device is related to the period of the diffraction pattern. That is, when the period of the diffraction pattern ranges from 300 nm to 600 nm, the optical device has high and uniform diffraction efficiency within a wide-angle range. On the other hand, when the period of the diffraction pattern exceeds the above range (see FIGS. 21C and 22C), the optical device has low diffraction efficiency.

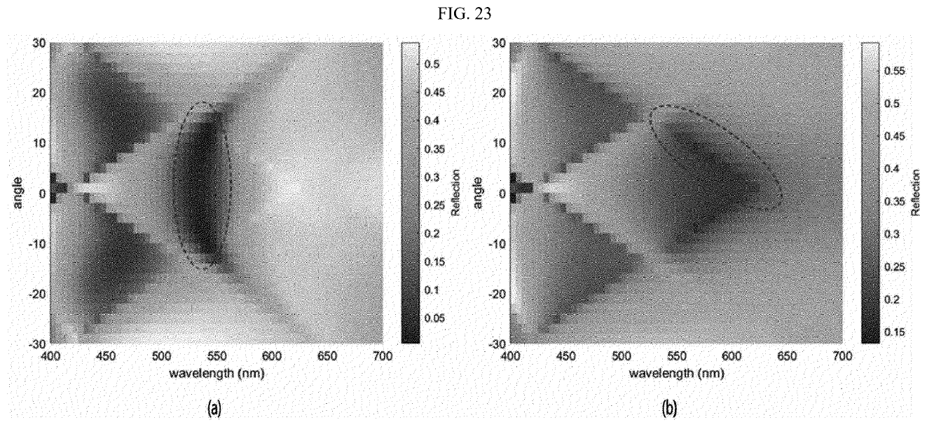

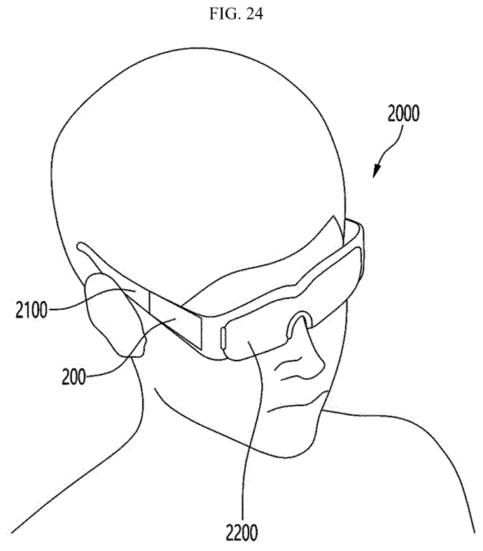

FIG. 23 is a graph for comparing diffraction efficiencies of optical devices according to the arrangement of the metal layer.

FIG. 23A shows a case in which the optical device includes a first metal layer and a second metal layer. In addition, FIG. 23B shows a case in which the optical device includes only the second metal layer.

Referring to FIG. 23A, a blue area with a low reflectivity is formed in an area of a narrow wavelength range. The blue area is an area that is diffracted through the diffraction pattern and incident into the light guide. Accordingly, when the optical device includes the first metal layer and the second metal layer, the optical device can have uniform diffraction efficiency at a wide angle.

On the other hand, referring to FIG. 23B, a blue area with a low reflectivity is formed in an area of a wide wavelength range. Accordingly, when the optical device includes only the second metal layer, the optical device cannot have uniform diffraction efficiency at a wide angle.

Accordingly, the optical device according to the embodiment can have uniform and high diffraction efficiency by the first metal layer and the second metal layer disposed at different positions.

Hereinafter, an example of a display device including the optical device according to the embodiment will be described with reference to FIG. 24.

Referring to FIG. 24, the optical device according to the embodiment may be applied to a wearable display device. Specifically, the optical device according to the embodiment may be applied to a wearable display device worn on the head or ears of a human body.

For example, a display device 2000 may be an AR device.

The display device 2000 includes a wearable unit 2100 and a display unit 2200.

The wearable unit 2100 may extend in one direction. The wearable unit 2100 may be worn on the body of a user. For example, the wearable unit 2100 is worn on the head or ears of the user so that the display device 2000 may be fixed to the body of the user. For example, the wearable unit 2100 may be a glasses frame in the wearable display device.

The light source member 200 is disposed on the wearable unit 2100. The light source member 200 emits light toward the display unit 2200. Specifically, the light source member 200 emits light including image information toward the display unit 2200. For example, the light source member 200 may be a projector.

The display unit 2200 may be the above-described optical device. Alternatively, the display unit 2200 may be AR glasses including the optical device.

Accordingly, the user may receive light including image information emitted from the light source member 200 through the display unit 2200. Accordingly, the user may recognize virtual reality and AR of real reality through the optical device.

The features, structures, effects, etc. described in the above-described embodiments are included in at least one embodiment and are not necessarily limited to only one embodiment. Furthermore, the features, structures, effects, etc. exemplified in each embodiment may be combined or modified and implemented in other embodiments by those skilled in the art to which the embodiments pertain. Accordingly, the descriptions related to such combinations and modifications should be construed as being included in the scope of the present invention.

In addition, although embodiments have been mainly described above, these embodiments are only exemplary and do not limit the present invention, and those skilled in the art to which the present invention pertains can know that various modifications and applications that are not exemplified above are possible without departing from the essential characteristics of the embodiments. For example, each component specifically shown in the embodiments may be implemented by modification thereof. In addition, differences related to these modifications and applications should be construed as being included in the scope of the present invention defined in the appended claims.

1. An optical device comprising:
a light guide including a first surface and a second surface; and
a diffraction structure disposed on any one surface of the first surface and the second surface,
wherein the diffraction structure includes a plurality of diffraction patterns spaced apart from each other, and includes a first metal layer disposed on one surface of the light guide and a second metal layer disposed on an upper surface of the diffraction patterns.

2. The optical device of claim 1, wherein light is incident toward the first surface, and
the first metal layer is disposed on the first surface.

3. The optical device of claim 1, wherein the diffraction structure includes a first diffraction structure disposed on an area on which light is incident and a second diffraction structure disposed on an area from which the light is emitted.

4. The optical device of claim 1, wherein the first metal layer and the second metal layer are disposed to be spaced apart from each other.

5. The optical device of claim 1, wherein a period, which is a distance the diffraction pattern repeats, is defined, and
the period ranges from 300 nm to 600 nm.

6. The optical device of claim 1, wherein a period, which is a distance the diffraction pattern repeats, is defined,
wherein a fill factor, which is a ratio of a width of the diffraction pattern to the period, is defined, and
wherein the fill factor ranges from 20% to 80%.

7. The optical device of claim 1, wherein a height of the diffraction pattern is in a range of from 30 nm to 500 nm.

8. The optical device of claim 1, wherein at least one of a thickness of the first metal layer and a thickness of the second metal layer is in a range of from 10 nm to 70 nm.

9. The optical device of claim 8, wherein a height of the diffraction pattern is at least 10 nm greater than the thickness of the first metal layer.

10. The optical device of claim 2, wherein the light transmits through the diffraction pattern, or is reflected from the diffraction pattern and is incident into the light guide.
